(19) United States
(12) Patent Application Publication
(10) Pub. No.: US 2023/0204736 A1
(43) Pub. Date: Jun. 29, 2023

(54) LIDAR SYSTEM, ECHO SIGNAL PROCESSING METHOD AND APPARATUS, AND ELECTRONIC DEVICE

(71) Applicant: SUTENG INNOVATION TECHNOLOGY CO., LTD., Shenzhen (CN)

(72) Inventor: Feng ZHANG, Shenzhen (CN)

(73) Assignee: SUTENG INNOVATION TECHNOLOGY CO., LTD., Shenzhen (CN)

(21) Appl. No.: 18/084,461

(22) Filed: Dec. 19, 2022

(30) Foreign Application Priority Data
Dec. 23, 2021 (CN) 202111589405X

(51) Int. Cl. G01S 7/493; G01S 17/32

(52) U.S. Cl. CPC G01S 7/493; G01S 17/32

(57) ABSTRACT

Embodiments of this application disclose a LiDAR system, an echo signal processing method and apparatus, and an electronic device, pertaining to the field of LiDAR sensors. The system includes: M emission units, M receiving units, N×M comparison units. N×M timing units, and a processing unit. N is a positive integer greater than 1 and M is a positive integer greater than 0. The method includes: obtaining at least two digital signals and at least two timing results respectively corresponding to echo signals based on at least two thresholds, where the thresholds, the digital signals, and the timing results are in one-to-one correspondence; and processing the echo signal based on the at least two digital signals and the at least two timing results.

### CROSS-REFERENCE TO RELATED APPLICATION

The present application claims the benefit of priority to China Patent Application No. 202111589405.X, filed on Dec. 23, 2021, the content of which is incorporated herein by reference in its entirety.

### TECHNICAL FIELD

This application relates to the field of LiDAR sensors, and in particular, to a LiDAR system, an echo signal processing method and apparatus, and an electronic device.

### BACKGROUND

A LiDAR system is a system that emits a laser beam to detect characteristics such as position, speed, or the like of a target. Based on a time-of-flight measurement method, a LiDAR obtains a distance between the LiDAR and a target by measuring a time interval between an emitted signal and a received echo signal. In the measurement method, the received echo signal is an analog signal and needs to be first converted into a digital pulse signal before the time interval between the emitted signal and the echo signal can be calculated. A common conversion method is to convert the analog echo signal into a digital echo signal through a comparator. The comparator receives the analog echo signal and compares the analog echo signal with a threshold, outputs an analog signal less than the threshold as 0, and outputs an analog signal greater than the threshold as 1.

### SUMMARY

Embodiments of this application provide a LiDAR system, an echo signal processing method and apparatus, and an electronic device, to improve the ranging accuracy and working reliability of the LiDAR system. Technical solutions are as follows.

According to a first aspect, an embodiment of this application provides a LiDAR system, where the system includes:

M emission units, M receiving units, N×M comparison units, N×M timing units, and a processing unit, where N is a positive integer greater than 1 and M is a positive integer greater than 0, where

each emission unit is electrically connected to the processing unit and the N timing units separately, each receiving unit is electrically connected to the N comparison units separately, each comparison unit is electrically connected to each timing unit correspondingly, and the processing unit is electrically connected to the N×M timing units separately;

each emission unit is configured to emit a laser signal;

each receiving unit is configured to receive an echo signal corresponding to the laser signal, and separately send the echo signal to the N comparison units corresponding to the receiving unit, where the N comparison units corresponding to each receiving unit are separately corresponding to N different thresholds;

each comparison unit is configured to convert the echo signal into a digital signal based on thresholds separately corresponding to the comparison units, and send the digital signal to a timing unit corresponding to the comparison unit;

each timing unit is configured to perform timing based on the laser signal and the digital signal, and send a timing result and the digital signal to the processing unit; and

the processing unit is configured to process the timing result and the digital signal.

According to a second aspect, an embodiment of this application provides an echo signal processing method, and the method is applied to the LiDAR system according to the first aspect, where the method includes:

obtaining at least two digital signals and at least two timing results respectively corresponding to echo signals based on at least two thresholds, where the thresholds, the digital signals, and the timing results are in one-to-one correspondence; and

processing the echo signal based on the at least two digital signals and the at least two timing results.

According to a third aspect, an embodiment of this application provides an echo signal processing apparatus, where the apparatus includes:

an obtaining module, configured to obtain at least two digital signals and at least two timing results respectively corresponding to echo signals based on at least two thresholds, where the thresholds, the digital signals, and the timing results are in one-to-one correspondence; and

a processing module, configured to process the echo signal based on the at least two digital signals and the at least two timing results.

According to a fourth aspect, an embodiment of this application provides a computer storage medium. The computer storage medium stores a plurality of instructions. The instructions are adapted to be loaded by a processor and execute the steps of the forgoing method.

According to a fifth aspect, an embodiment of this application provides an electronic device, including a processor and a memory, where the memory stores a computer program, and the computer program is capable of being loaded by the processor to perform the steps of the forgoing method.

The beneficial effects provided by the technical solutions of some embodiments of the present application include at least as follows.

In this application, each receiving unit is connected to the N comparison units and the N timing units. In this way, the N comparison units convert the echo signal into the N digital signals based on N different thresholds and obtain the N timing results corresponding to the N digital signals respectively through the N timing units. When processing the echo signal, the processing unit can extract more abundant echo signal features through the N digital signals and the N timing results. Based on such information, not only distance information can be obtained, but also an ambient noise level, normality or abnormality of the echo, strength of the echo signal, and the like can be sensed. By using such information, the echo signal is subjected to processing such as noise reduction, echo width correction, and emission power adjustment, which can improve the quality of a point cloud collected by the LiDAR system, thereby improving ranging accuracy and working reliability.

### BRIEF DESCRIPTION OF DRAWINGS

To explain embodiments of the present application or the technical solutions in the prior art more clearly, the following briefly introduces the drawings used in the embodiments or the prior art. The drawings in the following description are only some embodiments of the present application. The person skilled in the art may obtain other drawings based on these drawings without inventive labor.

FIG. 1 is a schematic structural diagram of a LiDAR system according to an embodiment of this application;

FIG. 2 is a schematic structural diagram of a LiDAR system according to an embodiment of this application;

FIG. 3 is a schematic flowchart of an echo signal processing method according to an embodiment of this application;

FIG. 4 is a schematic structural diagram of a LiDAR system according to an embodiment of this application;

FIG. 5 is a schematic diagram of an echo signal and a digital signal according to an embodiment of this application;

FIG. 6 is a schematic structural diagram of a LiDAR system according to an embodiment of this application;

FIG. 7 is a schematic diagram of an echo signal and a digital signal according to an embodiment of this application,

FIG. 8 is a schematic diagram of an echo signal and a digital signal according to an embodiment of this application:

FIG. 9 is a schematic structural diagram of a LiDAR system according to an embodiment of this application;

FIG. 10 is a schematic structural diagram of an echo signal processing apparatus according to an embodiment of this application; and

FIG. 11 is a schematic structural diagram of an electronic device according to an embodiment of this application.

### DETAILED DESCRIPTION

The following clearly describes the technical solutions in the embodiments of this application with reference to the drawings. The described embodiments are only some but not all of the embodiments of this application. All other embodiments obtained by a person of ordinary skill in the art based on the embodiments of this application without creative efforts shall fall within the protection scope of this application.

In the description of the present application, it shall be understood that the terms such as “first” and “second” are merely intended for a purpose of description, and shall not be understood as an indication or implication of relative importance. In the descriptions of this application, it should be understood that “include,” “have,” or any other variant thereof are intended to cover a non-exclusive inclusion unless otherwise specified and defined explicitly. For example, a process, a method, a system, a product, or a device that includes a series of steps or units is not limited to the listed steps or units, but optionally further includes an unlisted step or unit, or optionally further includes another inherent step or unit of the process, the method, the product, or the device. The person skilled in the art can understand specific meanings of the foregoing terms in the present application to a specific situation. In addition, in the descriptions of this application, “a plurality of” means two or more unless otherwise specified. Herein. “and/or” is an association relationship for describing associated objects and indicates that three relationships may exist. For example, A and/or B may mean the following three cases. Only A exists, both A and B exist, and only B exists. The character “/” generally indicates an “or” relationship between the associated objects.

This application is described in detail below with reference to embodiments.

A LiDAR system is a system that emits a laser beam to detect features such as position, distance, azimuth, and attitude of a target. Based on a time-of-flight measurement method, a LiDAR obtains a distance between the LiDAR and an obstacle by measuring a time interval between an emitted signal and a received echo signal. In the measurement method, the received echo signal is an analog signal and needs to be first converted into a pulse signal in a digital system before the time interval between the emitted signal and the echo signal can be calculated. A common conversion method is to convert the echo signal in the form of an analog signal into an echo signal in a form of a digital signal through a comparator. The comparator receives the echo signal in the form of the analog signal based on a threshold, outputs an analog signal less than the threshold as 0, and outputs an analog signal greater than the threshold as 1.

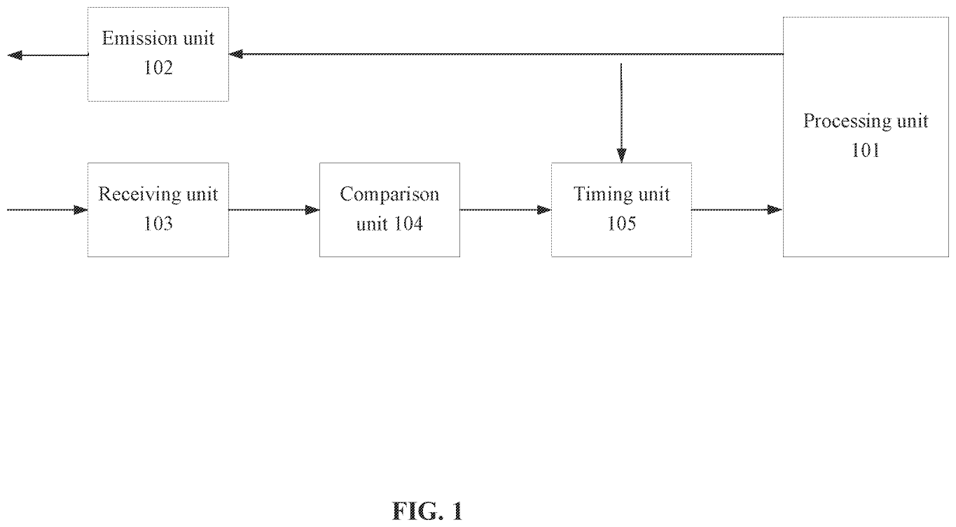

FIG. 1 is a schematic structural diagram of a LiDAR system in the related art. The LiDAR system includes: a processing unit 101, an emission unit 102, a receiving unit 103, a comparison unit 104, and a timing unit 105. The emission unit 102 is electrically connected to the processing unit 101 and the timing unit 105 separately. The receiving unit 103, the comparison unit 104, the timing unit 105, and the processing unit 101 are electrically connected in sequence.

In an embodiment, in the LiDAR system shown in FIG. 1 and all the following LiDAR systems, an on-chip bus structure is used for connection. In some embodiments, an advanced peripheral bus (APB) is used for connection, and the APB structure is one of the bus structures proposed by ARM Company based on an on-chip bus protocol (Advanced Microcontroller Bus Architecture, AMBA) and has advantages such as high-standard satisfaction and good stability.

A laser signal is emitted from the emission unit 102 to a to-be-detected object, and a start signal is simultaneously emitted to the timing unit 105, so that the timing unit 105 starts counting a clock signal based on a period T after receiving a reference signal. That is, each time one clock signal is received, a count is increased by one. An echo signal reflected from the to-be-detected object is received by the receiving unit 102, and the receiving unit 102 sends the echo signal to the comparison unit 104. The comparison unit 104 converts the echo signal into a digital signal based on a threshold and sends the digital signal to the timing unit 105. When the timing unit 105 receives one clock signal, the count is increased by one, to perform timing based on counts of the digital signal and the clock signal. For example, the timing unit 105 separately obtains a count H1 and a count H2 corresponding to a specific rising edge and falling edge of the digital signal. A receiving duration Tx(H₂−H₁) corresponding to the width of a specific signal segment with a value of 1 in the digital signal can be obtained. The processing unit 101 processes the digital signal by using the digital signal and the timing result. For example, the digital signal is restored to an analog signal, signal strength of the echo signal is obtained based on the signal segment with the value of 1 in the digital signal, and so on.

The to-be-detected object may be considered as a target object generating the echo signal. For example, in the field of autonomous driving, the to-be-detected object is a specific vehicle or a tree on a street. It can be understood that this application imposes no limitation on a counting method of the timing unit, an echo signal-based ranging method, and a width calculation method of the signal segment in the digital signal. Descriptions of the counting method and calculation method of the timing unit in all the following embodiments should be understood based on descriptions in a previous embodiment, which is only one exemplary embodiment showing a working principle of the timing unit. This application does not exclude one or more counting methods and calculation methods of any other timing unit.

Because the echo signal is converted into the digital signal based on only one threshold in the related art, even each receiving unit in a multi-channel LiDAR is only corresponding to only one comparison unit. That is, there is always only one threshold for converting one echo signal into a digital signal. This means that a collection rate of the echo signal feature carried in the echo signal is low, which is extremely unfavorable to the highly efficient processing of the echo signal and further affects the ranging accuracy.

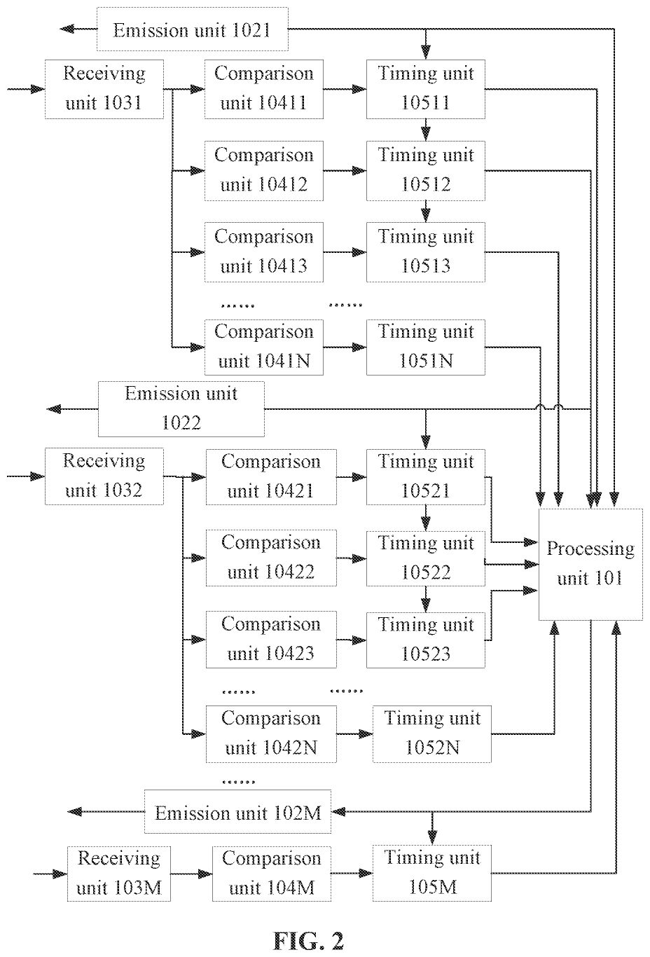

FIG. 2 is a schematic structural diagram of a LiDAR system according to an embodiment of this application. The LiDAR system in this embodiment of this application includes: M emission units, M receiving units, N×M comparison units, N-M timing units, and a processing unit 101, where N is a positive integer greater than 1 and M is a positive integer greater than 0. Each emission unit is electrically connected to the processing unit 101 and the N timing units separately, each receiving unit is electrically connected to the N comparison units separately, each comparison unit is electrically connected to each timing unit correspondingly, and the processing unit 101 is electrically connected to the N×M timing units separately.

In an embodiment, as shown in FIG. 2, an emission unit 1021 is electrically connected to a processing unit 101, a timing unit 10511, a timing unit 10512, a timing unit 10513, . . . , a timing unit 1051N separately; a receiving unit 1031 is electrically connected to a comparison unit 10411, a comparison unit 10412, a comparison unit 10413, . . . , a comparison unit 1041N separately; an emission unit 1022 is electrically connected to the processing unit 101, a timing unit 10521, a timing unit 10522, a timing unit 10523, . . . , a timing unit 1052N separately; a receiving unit 1032 is electrically connected to a comparison unit 10421, a comparison unit 10422, a comparison unit 10423, . . . , a comparison unit 1042N separately; an emission unit 102M is electrically connected to the processing unit 101 and a timing unit 105M separately; and a receiving unit 103M is electrically connected to a comparison unit 104M separately.

The N comparison units corresponding to each receiving unit correspond to N different thresholds respectively. For example, a threshold of the comparison unit 10411 corresponding to the receiving unit 1031 is X₁, a threshold of the comparison unit 10412 is X₂, and a threshold of the comparison unit 10413 is X₃.

In an embodiment, the N×M comparison units are corresponding to N×M thresholds respectively. For example, N thresholds corresponding to the receiving unit 1031 include X₁ to X_{N}, N thresholds corresponding to the receiving unit 1032 include Y₁ to Y_{N}, and N thresholds corresponding to the receiving unit 1033 include Z₁ to Z_{N}. Based on the plurality of thresholds, an extraction rate of the echo signal feature of the echo signal can be improved.

In another embodiment, N thresholds corresponding to each receiving unit are not exactly the same as N thresholds corresponding to another receiving unit. For example, the receiving unit 1031 is corresponding to four thresholds, namely X₁, X₂, X₃, and X₄; the receiving unit 1032 is corresponding to four thresholds, namely Y₁, Y₂, X₃, and X₄ respectively; and the receiving unit 1033 is corresponding to four thresholds, namely Y₁, Y₂, X₁, and X₂. This application also includes correspondence between another receiving unit and a threshold.

In an embodiment, each emission unit is not exactly corresponding to the same number of comparison units. For example, a first emission unit is corresponding to four comparison units, and the four comparison units are corresponding to four timing units respectively; a second emission unit is corresponding to five comparison units, and the five comparison units are corresponding to five timing units respectively; and a third emission unit is corresponding to four comparison units, and the four comparison units are corresponding to four timing units respectively. This application also includes the specific number of N comparison units corresponding to another receiving unit. In this embodiment, the number of comparison units and the number of timing units in each receiving channel of the multi-channel LiDAR are flexibly configured based on a ranging occasion and a ranging accuracy requirement.

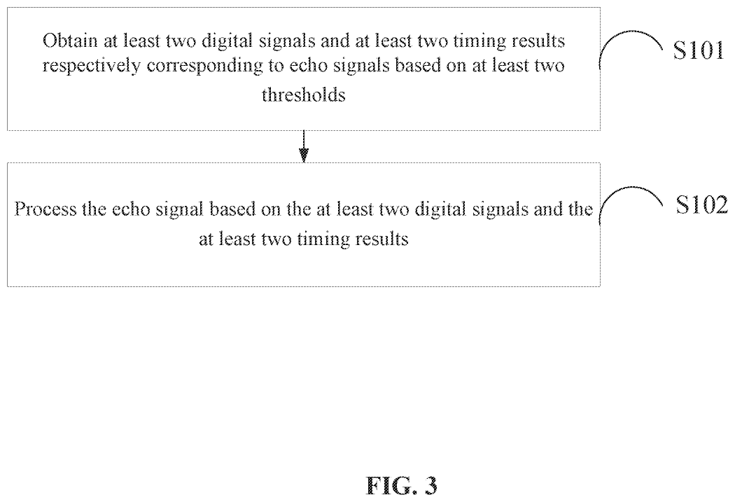

FIG. 3 shows an echo signal processing method according to an embodiment of this application. The method can be implemented through a computer program, which can run on an echo signal processing apparatus based on a Von Neumann architecture. The computer program can be integrated into an application or run as an independent tool application.

In an embodiment, the echo signal processing method includes the following steps.

S101. Obtain at least two timing results corresponding to echo signals respectively based on at least two thresholds.

Thresholds, digital signals, and timing results are in one-to-one correspondence.

A processor connected to N, M timing units receives a timing result of the digital signal sent by each timing unit, each digital signal is obtained by the comparison unit based on the echo signal and the respectively corresponding threshold, and the timing result is a plurality of rising edge times and a plurality of falling edge times of the digital signal.

For example, the processor 101 receives a first digital signal and a timing result sent from the timing unit 10511. The timing result includes a rising edge time T₁₁, a falling edge time T₁₂, a rising edge time T₁₃, a falling edge time T₁₄, a rising edge time T₁₅, a falling edge time T₁₆, and the like. The processor 101 receives a second digital signal and a timing result sent from the timing unit 10512. The timing result includes a rising edge time T₂₁, a falling edge time T₂₂, a rising edge time T₂₃, a falling edge time T₂₄, a rising edge time T₂₅, a falling edge time T₂₆, and the like.

S102. Process the echo signal based on the at least two digital signals and the at least two timing results.

The processor analyzes each digital signal based on the timing result corresponding to each digital signal, to extract the echo signal feature of the echo signal, and further processes the echo signal. The echo signal feature includes at least one or more of the following: a waveform of the echo signal, time-of-flight of the echo signal, an ambient noise level, normality or abnormality of the echo, and strength of the echo signal.

For example, the first digital signal is analyzed based on the first digital signal and the timing result of the timing unit 10511, the second digital signal is analyzed based on the second digital signal and the timing result of the timing unit 10512, the third digital signal is analyzed based on the third digital signal and the timing result of the timing unit 10513, and the fourth digital signal is analyzed based on an Nth digital signal and timing result of the timing unit 1051N. The N analysis results are the echo signal feature information of the echo signals received by the receiving unit 1031.

In this application, each receiving unit is connected to N comparison units and N timing units. In this way, the N comparison units convert the echo signal into the N digital signals based on N different thresholds and obtain the N timing results corresponding to the N digital signals respectively through the N timing units. When processing the echo signal, the processing unit can extract more abundant echo signal features through the N digital signals and the N timing results. Based on such information, not only distance information can be obtained, but also an ambient noise level, normality or abnormality of the echo, strength of the echo signal, and the like can be sensed. By using such information, the echo signal is subjected to processing such as noise reduction, echo width correction, and emission power adjustment, hence improving the quality of a point cloud collected by the LiDAR system, thereby improving ranging accuracy and working reliability.

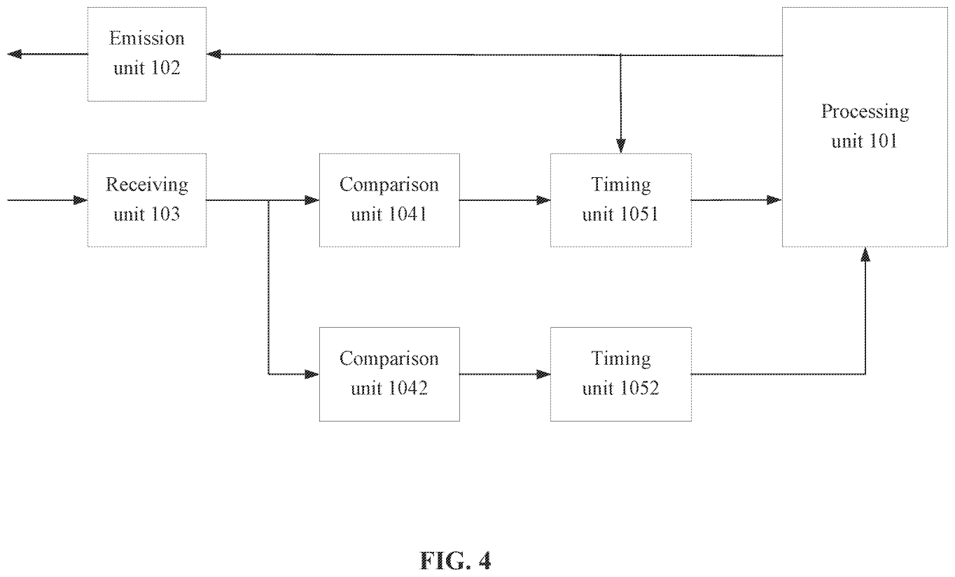

FIG. 4 is a schematic structural diagram of a LiDAR system according to an embodiment of this application. The LiDAR system includes: a processing unit 101, an emission unit 102, a receiving unit 103, a comparison unit 1041, a comparison unit 1042, a timing unit 1051, and a timing unit 1052. The emission unit 102 is electrically connected to the processing unit 101, the timing unit 1051, and the timing unit 1052 separately, the receiving unit 103 is electrically connected to the comparison unit 1041 and the comparison unit 1042 separately, the comparison unit 1041 is electrically connected to the timing unit 1051, and the comparison unit 1042 is electrically connected to the timing unit 1052. The comparison unit 1041 is corresponding to a first threshold, the comparison unit 1042 is corresponding to a second threshold, and values of the first threshold and the second threshold are different.

The following first comparison unit 1041 is the comparison unit 1041 shown in FIG. 4, the second comparison unit 1042 is the comparison unit 1042 shown in FIG. 4, the first timing unit 1051 is the timing unit 1051 shown in FIG. 4, the second timing unit 1052 is the timing unit 1052 shown in FIG. 4, and the first receiving unit 103 is the receiving unit 103 shown in FIG. 4.

In this embodiment, the first comparison unit 1041 is configured to convert an echo signal received by the receiving unit 103 into a first digital signal based on the first threshold of the first comparison unit 1041 and send the first digital signal to the first timing unit 1051.

The first timing unit 1051 is configured to perform timing based on the first digital signal and a laser signal emitted by an emission unit 102, and send a first timing result and the first digital signal to the processing unit 101.

The second comparison unit 1042 is configured to convert the echo signal into a second digital signal based on the second threshold, and send the second digital signal to the second timing unit 1052.

The second timing unit 1052 is configured to perform timing based on the second digital signal, and send a second timing result and the second digital signal to the processing unit 101.

The processing unit 101 is further configured to perform ranging processing based on the first timing result and the first digital signal; and based on the second timing result and the second digital signal, determine whether the first receiving unit 103 is in a receiving saturation state.

If the first receiving unit 103 is in the receiving saturation state, this may indicate that the signal strength of the echo signal exceeds the receiving range of the first receiving unit 103. For example, when there is a highly reflective object in the ranging range of the LiDAR system, or there is an object satisfying that a distance between the obstacle and the LiDAR system is less than a distance threshold, the first receiving unit 103 may be in the receiving saturation state.

In an embodiment, based on the second timing result, the processing unit 101 determines whether the second digital signal includes a signal segment satisfying that duration of the signal segment with a value of 1 exceeds a first duration threshold; and if yes, the processing unit 101 determines that the first receiving unit is in the receiving saturation state.

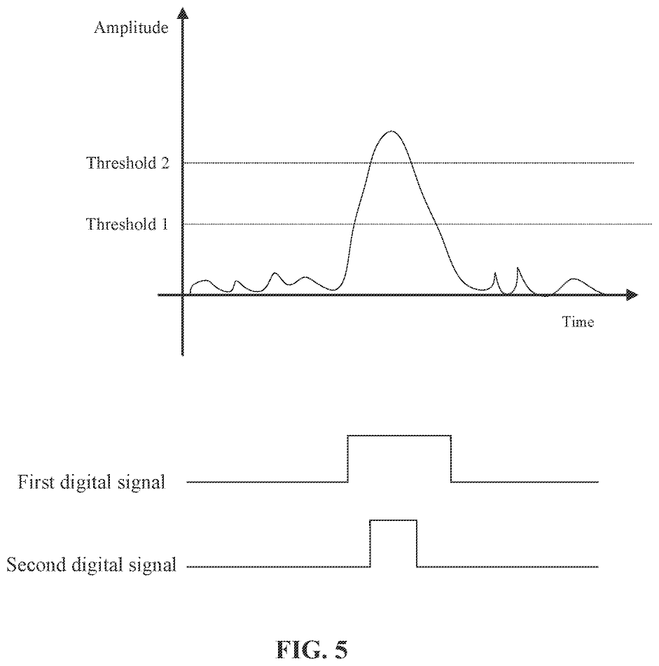

FIG. 5 is a schematic diagram of an echo signal and a digital signal according to an embodiment of this application. An upper figure in FIG. 5 is a waveform figure of an echo signal collected by the first receiving unit 1031, and a lower figure shows a signal segment of the first digital signal and a signal segment of the second digital signal, the first digital signal is obtained by the first comparison unit 1041 by converting the echo signal based on the first threshold (threshold 1 shown in FIG. 5), and the second digital signal is obtained by the second comparison unit 1042 by converting the echo signal based on the second threshold (threshold 2 shown in FIG. 5). It can be understood that waveform figures of echo signals and waveform figures of digital signals shown in FIG. 5 and all the following figures are only examples, which are not limited in this application.

As shown in FIG. 5, the processing unit 101 obtains the duration of the signal segment with a value of 1 in the second digital signal based on a timing result corresponding to the second digital signal. For example, the timing result includes a rising edge time and a falling edge time, and the duration of a signal segment with a value of 1 in the second digital signal may be obtained by deducting the falling edge time from the rising edge time. The duration of the signal segment is the width of the signal segment. If the duration of the signal segment with the value of 1 exceeds the first duration threshold, this may indicate that the width of the signal segment with the value of 1 exceeds a first width threshold.

When the duration of the signal segment with the value of 1 in the second digital signal exceeds the first duration threshold, it indicates that the amplitude of a specific echo segment in the echo signal exceeds a receiving threshold of the first receiving unit 103, and further indicates that the first receiving unit 103 is in the receiving saturation state. The specific value of the first duration threshold is set by a technician, and a specific value of the second threshold is determined by the hardware of the first receiving unit 103.

In an embodiment, after determining that the first receiving unit 103 is in the receiving saturation state, the processing unit 101 indicates the reducing emission power of the first emission unit 102. In this embodiment, the emission power of the first emission unit 102 is reduced, and the signal strength of the echo signal corresponding to the emitted laser signal is reduced, so as to reduce the signal amplitude of the echo signal, thereby avoiding echo signal loss during receiving due to the receiving unit being in the receiving saturation state.

In another embodiment, the N comparison units corresponding to another receiving unit connected to the processing unit 101 also include a first target comparison unit, and a threshold of the first target comparison unit is a threshold used to determine whether the receiving unit corresponding to the first target comparison unit is in the receiving saturation state. It can be understood that the foregoing N thresholds used to determine whether the N receiving units are in the receiving saturation state may be the same or different.

In an embodiment, second thresholds used to determine that the receiving unit is in the receiving saturation state may be a group of thresholds. For example, a receiving threshold of the first receiving unit is 100 A, and therefore, the second thresholds of the comparison unit are a group of thresholds. The group of thresholds are 98 A, 99 A, 100 A, 101 A, and 102 A separately, and each threshold is corresponding to one comparison unit. Based on the group of thresholds, whether the receiving unit is in the receiving saturation state can be more accurately determined. For example, when the receiving threshold changes due to a working condition (hardware aging, operating voltage reduction, overheating, or the like) of the receiving unit, the group of more specific second thresholds can be used to more accurately determine whether the receiving unit is in the receiving saturation state.

In this application, each receiving unit is connected to N comparison units and N timing units. In this way, the N comparison units convert the echo signal into the N digital signals based on N different thresholds, where N different thresholds include a threshold for ranging and a threshold for determining whether the receiving unit is in the receiving saturation state, and the N comparison units obtain the N timing results corresponding to the N digital signals respectively through the N timing units. When processing the echo signal, the processing unit can extract more abundant echo signal features through the N digital signals and the N timing results. Based on such information, not only distance information can be obtained, but also the strength of the echo signal and the like can be sensed, to determine whether the receiving unit is in the receiving saturation state. By using such information, the echo signal is subjected to processing such as emission power adjustment, hence improving the quality of a point cloud collected by the LiDAR system, thereby improving ranging accuracy and working reliability.

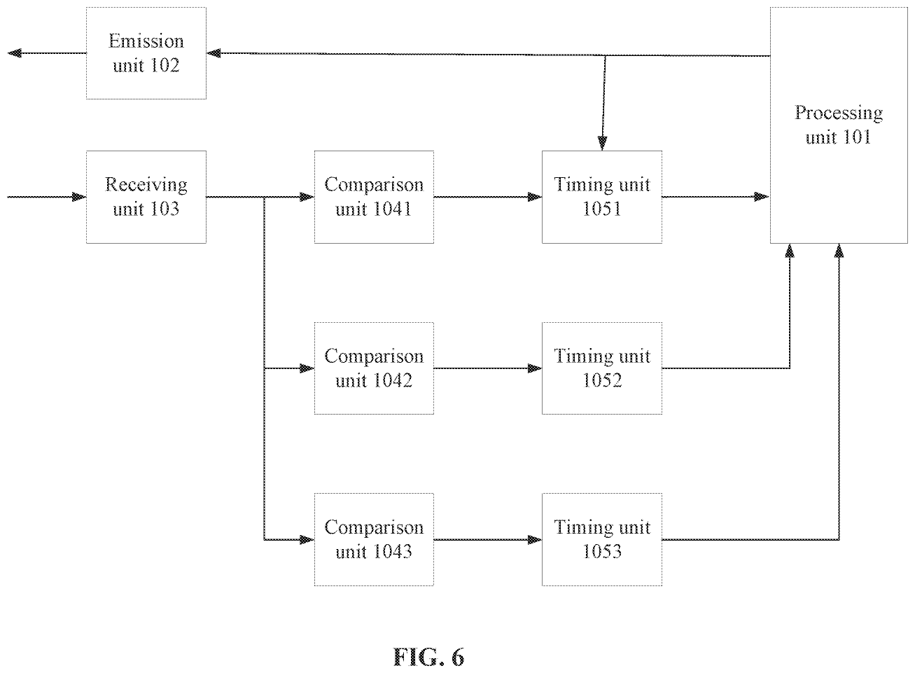

FIG. 6 is a schematic structural diagram of a LiDAR system according to an embodiment of this application. The LiDAR system includes: a processing unit 101, an emission unit 102, a receiving unit 103, a comparison unit 1041, a comparison unit 1042, a comparison unit 1043, a timing unit 1051, a timing unit 1052, and a timing unit 1053. The emission unit 102 is electrically connected to the processing unit 101, the timing unit 1051, the timing unit 1052, and the timing unit 1053 separately, the receiving unit 103 is electrically connected to the comparison unit 1041, the comparison unit 1042, and the comparison unit 1043 separately, the comparison unit 1041 is electrically connected to the timing unit 1051, the comparison unit 1042 is electrically connected to the timing unit 1052, and the comparison unit 1043 is electrically connected to the timing unit 1053.

The following first comparison unit 1041 is the comparison unit 1041 shown in FIG. 6, the second comparison unit 1042 is the comparison unit 1042 shown in FIG. 6, the third comparison unit 1043 is the comparison unit 1043 shown in FIG. 6, the first timing unit 1051 is the timing unit 1051 shown in FIG. 6, the second timing unit 1052 is the timing unit 1052 shown in FIG. 6, the third timing unit 1053 is the timing unit 1053 shown in FIG. 6, and the first receiving unit 103 is the receiving unit 103 shown in FIG. 6.

For working principles of the first comparison unit 1041, the second comparison unit 1042, the first timing unit 1051, and the second timing unit 1052, refer to FIG. 4. Details are not described herein again.

The third comparison unit 1043 is configured to convert the echo signal into a third digital signal based on the third threshold of the third comparison unit 1043, and send the third digital signal to the third timing unit 1053.

The third timing unit 1053 is configured to perform timing based on the second digital signal and a laser signal emitted by the first receiving unit 103, and send a third timing result and the third digital signal to the processing unit 101.

Based on the third timing result and the third digital signal, the processing unit 101 determines whether there is ambient noise in the echo signal. The ambient noise may indicate that the echo signal includes not only a reflected light signal generated by the laser signal, but also a light signal caused by ambient light or other light. For example, when the LiDAR system works in a strong light environment, more ambient noise may be caused in the echo signal.

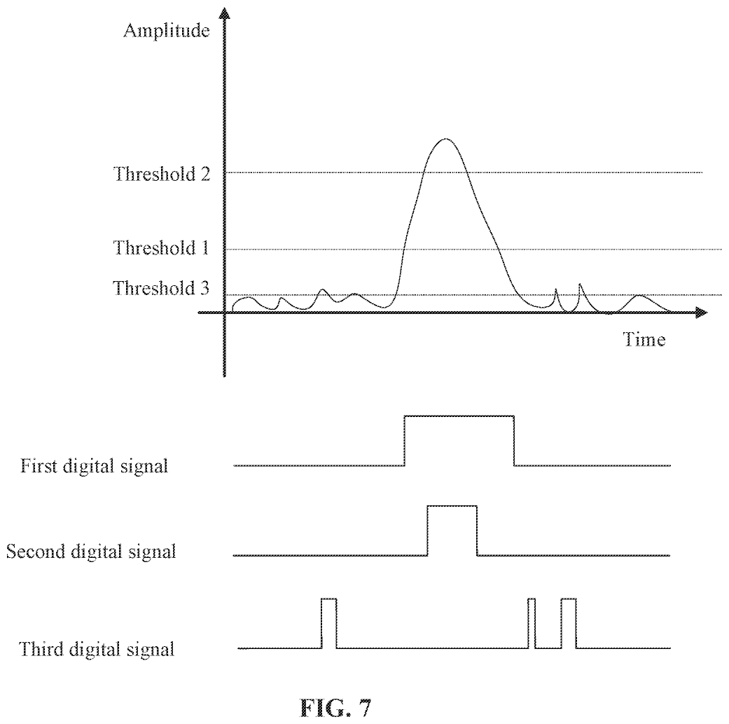

FIG. 7 is a schematic diagram of an echo signal and a digital signal according to an embodiment of this application. The upper portion of FIG. 7 shows a waveform of an echo signal collected by the first receiving unit 1031. The lower portion of FIG. 7 shows a signal segment of the first digital signal and signal segments of the second digital signal and the third digital signal. The first digital signal is obtained by converting the echo signal based on the first threshold (threshold 1 shown in FIG. 7) by the first comparison unit 1041, the second digital signal is obtained by converting the echo signal based on the second threshold (threshold 2 shown in FIG. 7) by the second comparison unit 1042, and the third digital signal is obtained by converting the echo signal based on the third threshold (threshold 3 shown in FIG. 7) by the third comparison unit 1043.

As shown in FIG. 7, based on the third timing result and the third digital signal converted from the echo signal based on the third threshold, the processing unit 101 obtains a signal segment satisfying that the duration of the signal segment with a value of 1 in the third digital signal exceeds a second duration threshold, and obtains the number of signal segments satisfying that the duration of the signal segments with values of 1 exceeds the second duration threshold. For example, the third digital signal shown in FIG. 7 includes three signal segments with the value of 1, and the width of two of the three signal segments with the value of 1 exceeds the second width threshold. That is, the third digital signal includes two signal segments satisfying that the duration of the two signal segments with values of 1 exceeds the second duration threshold.

When the third digital signal includes a signal segment satisfying that the duration of the signal segment with a value of 1 exceeds a second duration threshold and the number of signal segments satisfying that the duration of the signal segments with values of 1 exceeds the second duration threshold exceeds a number threshold, it is determined that there is ambient noise in the first digital signal That is, there is a noise signal in the echo signal. For example, in this case, the LiDAR system is in a strong light environment.

Specific values of the second duration threshold and the third threshold are set by an operator. For example, the third threshold is obtained based on a working environment and a working requirement of the LiDAR system. An exemplary LiDAR system is a LiDAR system of a tracker that mostly works indoors. Another LiDAR system is a vehicle-mounted LiDAR that mostly works outdoors. A third threshold of a previous LiDAR system is less than that of the current LiDAR system.

In an embodiment, after determining that there is ambient noise in the echo signal, the processing unit is further configured to perform noise reduction processing on the first digital signal. In this application, based on the third digital signal obtained through the third threshold and the third timing result, it is determined whether there is noise in the first digital signal or the echo signal, so as to perform noise reduction processing on the first digital signal, thereby improving ranging accuracy of the LiDAR system.

In another embodiment, the N comparison units corresponding to another receiving unit connected to the processing unit 101 also include a second target comparison unit. A threshold of the second target comparison unit is a threshold used to determine whether there is noise in the echo signal received by the receiving unit corresponding to the second target comparison unit. It can be understood that the foregoing N thresholds used to determine whether there is noise in the N echo signals may be the same or different.

In an embodiment, based on the LiDAR system shown in FIG. 6, the comparison unit 1043 includes a fourth threshold. The following fourth comparison unit is the comparison unit 1043 shown in FIG. 6, and the fourth timing unit is the timing unit 1053 shown in FIG. 6.

The fourth comparison unit is configured to convert the echo signal into a fourth digital signal based on the fourth threshold, and send the fourth digital signal to the fourth timing unit.

The fourth timing unit is configured to perform timing based on the fourth digital signal, and send a fourth timing result and the fourth digital signal to the processing unit 101.

Based on the first timing result, the first digital signal, the second timing result, and the second digital signal, or based on the first timing result, the first digital signal, the fourth timing result, and the fourth digital signal, the processing unit 101 determines whether there is echo superposition in the echo signal. If there is an echo superposition in the echo signal, this may indicate that when two or more echo signals are partially overlapped, the echo superposition is formed. As a result, a serious deviation occurs when the LiDAR system determines the signal strength of the echo signal based on the digital signal converted from the echo signal with echo superposition, thereby decreasing ranging accuracy.

In an embodiment, based on the first timing result, the first digital signal, the second timing result, and the second digital signal, or based on the first timing result, the first digital signal, the fourth timing result, and the fourth digital signal, determining, by the processing unit 101, whether there is echo superposition in the echo signal includes: determining whether receiving time of a first digital signal segment with a value of 1 is overlapped with receiving time of a fourth digital signal segment with a value of 0, and the overlapped duration exceeds a third duration threshold; or whether receiving time of a fourth digital signal segment with a value of 1 is overlapped with receiving time of a second digital signal segment with a value of 0, and the overlapped duration exceeds a fourth duration threshold. If yes, then it is determined that there is an echo superposition in the echo signal.

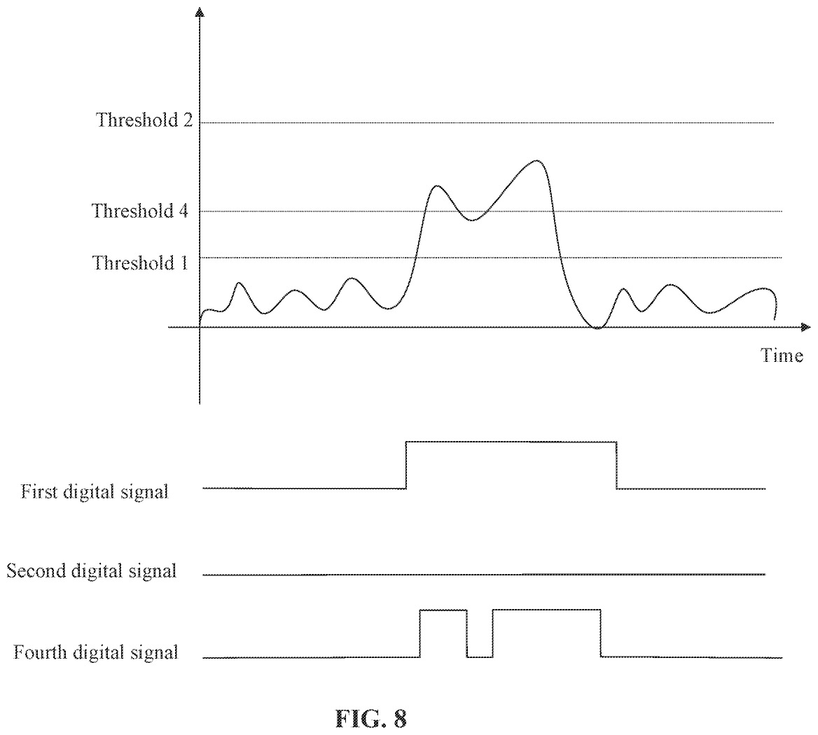

FIG. 8 is a schematic diagram of an echo signal and a digital signal according to an embodiment of this application. The upper portion of FIG. 8 shows a waveform of an echo signal collected by the first receiving unit 1031, and the lower portion of FIG. 8 shows a signal segment of the first digital signal and signal segments of the second digital signal and the fourth digital signal. The first digital signal is obtained by converting the echo signal based on the first threshold (threshold 1 shown in FIG. 8) by the first comparison unit 1041, the second digital signal is obtained by converting the echo signal based on the second threshold (threshold 2 shown in FIG. 8) by the second comparison unit 1042, and the third digital signal is obtained by converting the echo signal based on the fourth threshold (threshold 4 shown in FIG. 8) by the fourth comparison unit.

As shown in FIG. 8, the echo signal with the echo superposition is characterized in that amplitude of the echo signal exceeds a first threshold but does not exceed a fourth threshold, or the amplitude exceeds the fourth threshold but does not exceed the second threshold. That is, the receiving unit 101 detects that receiving time of a first digital signal segment with a value of 1 is overlapped with receiving time of a fourth digital signal segment with a value of 0, and the overlapped duration exceeds a third duration threshold; or that receiving time of a fourth digital signal segment with a value of 1 is overlapped with receiving time of a second digital signal segment with a value of 0, and the overlapped duration exceeds a fourth duration threshold. For example, based on the foregoing determining criteria, an echo signal corresponding to the first digital signal segment with a value of 1 shown in FIG. 8 is the echo signal with echo superimposition.

Specific values of the third duration threshold and the fourth duration threshold are set by the operator. The fourth threshold is half of the second threshold, and the second threshold is a threshold used to determine whether the receiving unit is in the receiving saturation state.

In another embodiment, the N comparison units corresponding to another receiving unit connected to the processing unit 101 also include a third target comparison unit, and a threshold of the third target comparison unit is a threshold used to determine whether there is echo superimposition in the echo signal received by the receiving unit corresponding to the third target comparison unit. It can be understood that the foregoing N thresholds used to determine whether there is echo superimposition in the N echo signals may be the same or different.

In an embodiment, the third threshold and/or the fourth threshold each may be a group of thresholds. For example, a receiving threshold of the first receiving unit is 100 A, and therefore, the fourth thresholds of the comparison unit are a group of thresholds, the group of thresholds are 48 A, 49 A, 50 A, 51 A and 52 A separately, and each threshold is corresponding to one comparison unit. Based on the group of thresholds, whether there is echo superposition in the echo signal can be more accurately determined. For example, when the receiving threshold changes due to a working condition (hardware aging, operating voltage reduction, overheating, or the like) of the receiving unit, the group of more specific second thresholds can be used to more accurately determine whether there is echo superposition in the echo signal.

In an embodiment, after determining that there is echo superposition in the echo signal, the processing unit 101 compensates for the first digital signal. Compensation is performed to eliminate impact of echo superposition on analysis of the echo signal.

In an embodiment, compensation may be to multiply, by a compensation coefficient less than 1, amplitude data of the echo signal determined as experiencing the echo superposition phenomenon. For example, the signal segment with the value of 1 in the first digital signal shown in FIG. 8 is a digital signal segment corresponding to the signal segment with the echo superposition phenomenon, the width of the digital signal segment is 150, and the amplitude of the corresponding signal segment with the echo superposition phenomenon is inferred to be 80A. The amplitude or the width of the signal segment is multiplied by a compensation coefficient of 0.8 (a specific value of the compensation coefficient is not limited in this application), and therefore, the amplitude of the compensated echo signal is 64 A, and reflectivity information of the obstacle is determined based on the compensated echo signal. In this embodiment, the echo signal with echo superimposition is compensated for to improve the ranging accuracy.

In this application, each receiving unit is connected to N comparison units and N timing units. In this way, the N comparison units convert the echo signal into the N digital signals based on N different thresholds, where N different thresholds include a threshold for ranging and a threshold for determining whether there is noise or echo superimposition in the echo signal, and the N comparison units obtain the N timing results corresponding to the N digital signals respectively through the N timing units. When processing the echo signal, the processing unit can extract more abundant echo signal features through the N digital signals and the N timing results. Based on such information, not only distance information can be obtained, but also the strength of the echo signal and the like can be sensed, to determine whether there is noise or echo superimposition in the echo signal. By using such information, the echo signal is compensated for to reduce noise, hence improving the quality of a point cloud collected by the LiDAR system, thereby improving ranging accuracy and working reliability.

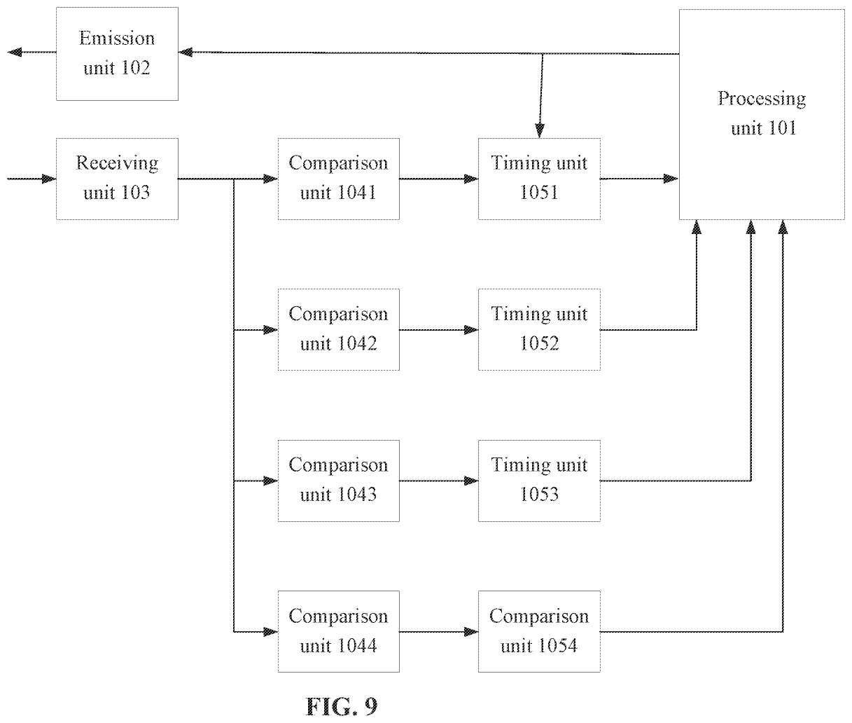

FIG. 9 is a schematic structural diagram of a LiDAR system according to an embodiment of this application. The LiDAR system includes, a processing unit 101, an emission unit 102, a receiving unit 103, a comparison unit 1041, a comparison unit 1042, a comparison unit 1043, a comparison unit 1044, a timing unit 1051, a timing unit 1052, a timing unit 1053, and a timing unit 1054. The emission unit 102 is electrically connected to the processing unit 101, the timing unit 1051, the timing unit 1052, the timing unit 1053, and the timing unit 1054 separately, the receiving unit 103 is electrically connected to the comparison unit 1041, the comparison unit 1042, the comparison unit 1043, and the comparison unit 1044 separately, the comparison unit 1041 is electrically connected to the timing unit 1051, the comparison unit 1042 is electrically connected to the timing unit 1052, the comparison unit 1043 is electrically connected to the timing unit 1053, and the comparison unit 1044 is electrically connected to the timing unit 1054.

The comparison unit 1041 in FIG. 9 is the first comparison unit 1041 shown in FIG. 4, the timing unit 1051 is the first timing unit 1051 shown in FIG. 4, and the first comparison unit 1041 includes a first threshold. The processing unit 101 performs ranging processing based on the first timing result and the first digital signal obtained through the first threshold.

The comparison unit 1042 in FIG. 9 is the second comparison unit 1042 shown in FIG. 4, the timing unit 1052 is the second timing unit 1052 shown in FIG. 4, and the second comparison unit 1042 includes a second threshold. Based on the second timing result and the second digital signal obtained through the second threshold, the processing unit 101 determines whether the first receiving unit 103 is in a receiving saturation state.

The comparison unit 1043 in FIG. 9 is the third comparison unit 1043 shown in FIG. 6, the timing unit 1053 is the third timing unit 1053 shown in FIG. 6, and the third comparison unit 1043 includes a third threshold. Based on the third timing result and the third digital signal obtained through the third threshold, the processing unit 101 determines whether there is noise in the echo signal.

The comparison unit 1044 in FIG. 9 is the fourth comparison unit shown in FIG. 4, the timing unit 1054 is the fourth timing unit shown in FIG. 4, and the fourth comparison unit includes a fourth threshold. Based on the fourth timing result and the fourth digital signal obtained through the fourth threshold, the processing unit 101 determines whether there is echo superposition in the echo signal.

For a working principle of the foregoing units, refer to FIG. 4 to FIG. 8. Details are not described herein again.

In an embodiment, the LiDAR system further includes M receiving units and M emission units, N comparison units corresponding to each receiving unit include a third comparison unit, and the third comparison unit includes a third threshold, that is, the number of third comparison units is M. Based on the third timing result and the third digital signal obtained through the third threshold, the processing unit 101 determines whether there is noise in the echo signal. In other words, each channel of the multi-channel LiDAR system has the same noise threshold.

In this application, each receiving unit is connected to N comparison units and N timing units. In this way, the N comparison units convert the echo signal into the N digital signals based on N different thresholds and obtain the N timing results corresponding to the N digital signals respectively through the N timing units. When processing the echo signal, the processing unit can extract more abundant echo signal features through the N digital signals and the N timing results. Based on such information, not only distance information can be obtained, but also an ambient noise level, normality or abnormality of the echo, strength of the echo signal, and the like can be sensed. By using such information, the echo signal is subjected to processing such as noise reduction, echo width correction, and emission power adjustment, which can improve the quality of a point cloud collected by the LiDAR system, thereby improving ranging accuracy and working reliability.

A device embodiment of this application is provided below, and can be used to perform the method embodiments of this application. For details not disclosed in this device embodiment of this application, refer to the method embodiments of this application.

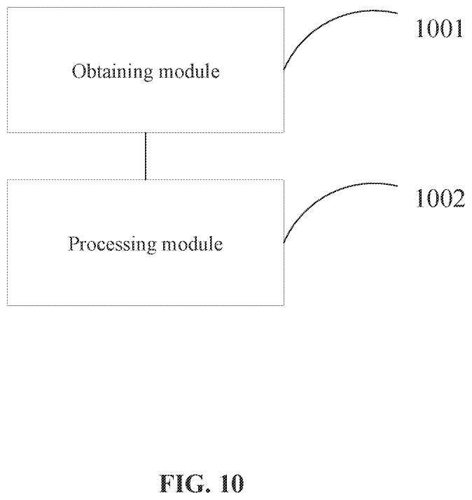

FIG. 10 is a schematic structural diagram of an echo signal processing apparatus according to an exemplary embodiment of this application. The echo signal processing apparatus can be implemented as all or a part of the apparatus through software, hardware, or a combination thereof. The echo signal processing apparatus includes an obtaining module 1001 and a processing module 1002.

The obtaining module 1001 is configured to obtain at least two digital signals and at least two timing results respectively corresponding to echo signals based on at least two thresholds, where the thresholds, the digital signals, and the timing results are in one-to-one correspondence.

The processing module 1002 is configured to process the echo signal based on the at least two digital signals and the at least two timing results.

In this application, each receiving unit is connected to N comparison units and N timing units. In this way, the N comparison units convert the echo signal into the N digital signals based on N different thresholds and obtain the N timing results corresponding to the N digital signals respectively through the N timing units. When processing the echo signal, the processing unit can extract more abundant echo signal features through the N digital signals and the N timing results. Based on such information, not only distance information can be obtained, but also an ambient noise level, normality or abnormality of the echo, strength of the echo signal, and the like can be sensed. By using such information, the echo signal is subjected to processing such as noise reduction, echo width correction, and emission power adjustment, which can improve the quality of a point cloud collected by the LiDAR system, thereby improving ranging accuracy and working reliability.

It should be noted that, when the echo signal processing apparatus provided in the foregoing embodiment performs the echo signal processing method, division of the foregoing functional modules is used as an example for illustration. In actual application, the foregoing functions can be allocated to different functional modules for implementation based on a requirement. That is, an inner structure of the device is divided into different functional modules to implement all or some of the functions described above. In addition, embodiments of the echo signal processing apparatus and the echo signal processing method provided above pertain to a same concept. For a specific implementation process, refer to the method embodiments. Details are not described herein again.

Serial numbers of the embodiments of this application are only intended for description, and do not indicate advantages or disadvantages of the embodiments.

An embodiment of this application further provides a computer storage medium. The computer storage medium may store a plurality of instructions. The instructions are capable of being loaded by a processor to perform the foregoing echo signal processing method in the embodiments shown in FIG. 1 to FIG. 9. For an exemplary execution process, refer to the description of the embodiments shown in FIG. 1 to FIG. 9. Details are not described herein again.

This application further provides a computer program product. The computer program product stores at least one instruction. The at least one instruction is capable of being loaded by the processor to perform the echo signal processing method in the embodiments shown in FIG. 1 to FIG. 9. For an exemplary execution process, refer to the description of the embodiments shown in FIG. 1 to FIG. 9. Details are not described herein again.

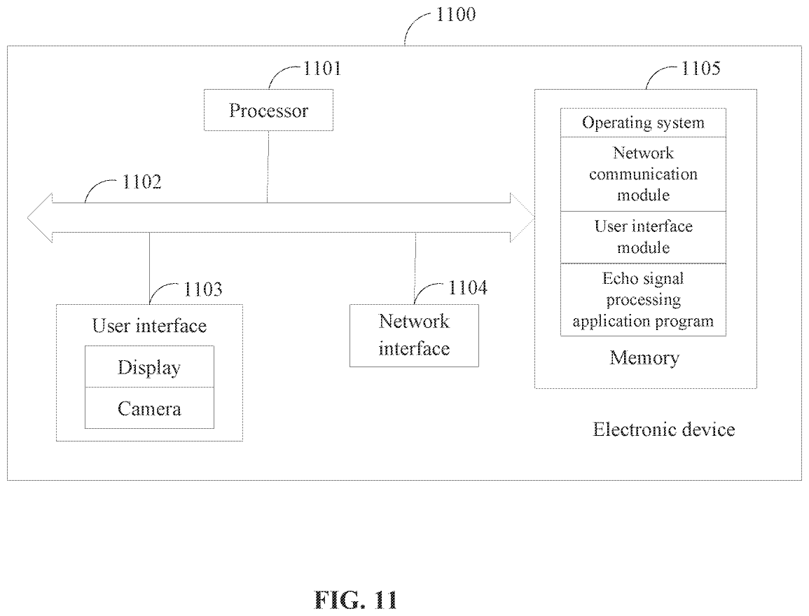

FIG. 11 is a schematic structural diagram of an electronic device according to an embodiment of this application. As shown in FIG. 11, the electronic device 1100 may include: at least one processor 1101, at least one network interface 1104, a user interface 1103, a memory 1105, and at least one communication bus 1102.

Herein, the communication bus 1102 is configured to implement an electrical connection and communication between these components.

Herein, the user interface 1103 may include a display and a camera. In some embodiments, the user interface 1103 may further include a standard wired interface and a wireless interface.

Herein, the network interface 1104 may include a standard wired interface and a wireless interface (such as, a Wi-Fi interface).

Herein, the processor 1101 may include one or more processing cores. The processor 1101 uses various interfaces and circuits to electrically connect various parts of the entire server 1100, and executes various functions and processes data of the server 1100 by running or executing instructions, programs, code sets, or instruction sets stored in the memory 1105, and invoking data stored in the memory 1105. In some embodiments, the processor 1101 may be realized in at least one hardware form of digital signal processing (DSP), field-programmable gate array (FPGA), and programmable logic array (PLA). The processor 1101 may integrate a combination of one or more of a central processing unit (CPU), a graphics processing unit (GPU), a modem, and the like. The GPU is configured to render and draw content that needs to be displayed on a display. The modem is configured to process wireless communication. It may be understood that the forgoing modem may not be integrated into the processor 1101, and may be implemented by one chip independently.

The memory 1105 may include a random access memory (RAM), or a read-only memory (ROM). In some embodiments, the memory 1105 includes a non-transitory computer-readable medium. The memory 1105 may be configured to store instructions, programs, codes, code sets, or instruction sets. The memory 1105 may include a program storage region and a data storage region. The program storage region may store instructions for implementing the operating system, instructions for at least one function (such as a touch control function, a sound play function, and an image play function), and instructions for implementing each of the foregoing method embodiments. In some embodiments, the memory 1105 may also be at least one storage device distant from the forgoing processor 1101. As shown in FIG. 11, as a computer storage medium, the memory 1105 may include an operating system, a network communication module, a user interface module, and an echo signal processing application program.

In the electronic device 1100 shown in FIG. 11, the user interface 1103 is mainly configured to provide an input interface for a user to obtain data input by the user, and the processor 1101 can be used to invoke an echo signal processing application program stored in the memory 1105, and perform the following operations:

obtaining at least two digital signals and at least two timing results respectively corresponding to echo signals based on at least two thresholds, where the thresholds, the digital signals, and the timing results are in one-to-one correspondence; and

processing the echo signal based on the at least two digital signals and the at least two timing results.

In another embodiment, the processor 1101 is the processing unit 101 in the embodiments shown in FIG. 1 to FIG. 9.

In this application, each receiving unit is connected to N comparison units and N timing units. In this way, the N comparison units convert the echo signal into the N digital signals based on N different thresholds and obtain the N timing results corresponding to the N digital signals respectively through the N timing units. When processing the echo signal, the processing unit can extract more abundant echo signal features through the N digital signals and the N timing results. Based on such information, not only distance information can be obtained, but also an ambient noise level, normality or abnormality of the echo, strength of the echo signal, and the like can be sensed. By using such information, the echo signal is subjected to processing such as noise reduction, echo width correction, and emission power adjustment, which can improve the quality of a point cloud collected by the LiDAR system, thereby improving ranging accuracy and working reliability.

The person skilled in the art can understand that all or part of procedures in methods of the forgoing embodiments can be implemented by instructing relevant hardware via a computer program. The program can be stored in a computer-readable storage medium. During execution, the computer program can include the procedures of the embodiments of the foregoing methods. A storage medium can be a magnetic disk, an optical disc, the read-only storage memory or the random storage memory, and so on.

The disclosed foregoing are only exemplary embodiments of the present application, which cannot be used to limit the scope of rights of the present application. Therefore, equivalent changes made in accordance with the claims of the present application still fall within the scope of the application.

What is claimed is:

1. A LiDAR system, comprising:
M emission units, M receiving units, N×M comparison units, N×M timing units, and a processing unit, wherein N is a positive integer greater than 1 and M is a positive integer greater than 0, wherein
each emission unit is electrically connected to the processing unit and the N timing units separately, each receiving unit is electrically connected to the N comparison units separately, each comparison unit is electrically connected to each timing unit correspondingly, and the processing unit is electrically connected to the N×M timing units separately;
each emission unit is configured to emit a laser signal;
each receiving unit is configured to receive an echo signal corresponding to the laser signal, and separately send the echo signal to the N comparison units corresponding to the receiving unit, wherein the N comparison units corresponding to each receiving unit are separately corresponding to N different thresholds;
each comparison unit is configured to convert the echo signal into a digital signal based on thresholds separately corresponding to the comparison units, and send the digital signal to a timing unit corresponding to the comparison unit;
each timing unit is configured to perform timing based on the laser signal and the digital signal, and send a timing result and the digital signal to the processing unit; and
the processing unit is configured to process the timing result and the digital signal.

2. The LiDAR system according to claim 1, wherein the M emission units comprise a first emission unit, the N comparison units and the N timing units corresponding to a first receiving unit respectively comprise a first comparison unit and a first timing unit, and the first comparison unit is electrically connected to the first timing unit, wherein the first comparison unit comprises a first threshold;
the first comparison unit is configured to convert the echo signal into a first digital signal based on the first threshold, and send the first digital signal to the first timing unit;
the first timing unit is configured to perform timing based on the first digital signal, and send a first timing result and the first digital signal to the processing unit; and
the processing unit is further configured to perform ranging processing based on the first timing result and the first digital signal.

3. The LiDAR system according to claim 2, wherein the N comparison units and the N timing units corresponding to the first receiving unit respectively comprise a second comparison unit and a second timing unit, and the second comparison unit is electrically connected to the second timing unit, wherein the second comparison unit comprises a second threshold:
the second comparison unit is configured to convert the echo signal into a second digital signal based on the second threshold, and send the second digital signal to the second timing unit;
the second timing unit is configured to perform timing based on the second digital signal, and send a second timing result and the second digital signal to the processing unit; and
the processing unit is further configured to, based on the second timing result and the second digital signal, determine whether the first receiving unit is in a receiving saturation state.

4. The LiDAR system according to claim 3, wherein after determining that the first receiving unit is in the receiving saturation state, the processing unit is further configured to indicate reducing emission power of the first emission unit.

5. The LiDAR system according to claim 3, wherein
the processing unit is configured to, based on the second timing result, determine whether the second digital signal comprises a signal segment satisfying that duration of the signal segment with a value of 1 exceeds a first duration threshold; and
if yes, determine that the first receiving unit is in the receiving saturation state.

6. The LiDAR system according to claim 2, wherein the N comparison units and the N timing units corresponding to the first receiving unit respectively comprise a third comparison unit and a third timing unit, and the third comparison unit is electrically connected to the third timing unit, wherein the third comparison unit comprises a third threshold;
the third comparison unit is configured to convert the echo signal into a third digital signal based on the third threshold, and send the third digital signal to the third timing unit;
the third timing unit is configured to perform timing based on the third digital signal, and send a third timing result and the third digital signal to the processing unit; and
the processing unit is further configured to, based on the third timing result and the third digital signal, determine whether there is ambient noise in the echo signal.

7. The LiDAR system according to claim 6, wherein after determining that there is ambient noise in the echo signal, the processing unit is further configured to perform noise reduction processing on the first digital signal.

8. The LiDAR system according to claim 6, wherein
the processing unit is configured to, based on the third timing result, determine whether the third digital signal comprises a signal segment satisfying that duration of the signal segment with a value of 1 exceeds a second duration threshold and a number of signal segments satisfying that the duration of the signal segments with values of 1 exceeds the second duration threshold exceeds a number threshold; and
if both yes, determine that there is ambient noise in the first digital signal.

9. The LiDAR system according to claim 3, wherein the N comparison units and the N timing units corresponding to the first receiving unit respectively comprise a fourth comparison unit and a fourth timing unit, and the fourth comparison unit is electrically connected to the fourth timing unit, wherein the fourth comparison unit comprises a fourth threshold;
the fourth comparison unit is configured to convert the echo signal into a fourth digital signal based on the fourth threshold, and send the fourth digital signal to the fourth timing unit;
the fourth timing unit is configured to perform timing based on the fourth digital signal, and send a fourth timing result and the fourth digital signal to the processing unit; and
the processing unit is further configured to, based on the first timing result, the first digital signal, the second timing result, and the second digital signal, or based on the first timing result, the first digital signal, the fourth timing result, and the fourth digital signal, determine whether there is echo superposition in the echo signal.

10. The LiDAR system according to claim 9, wherein the processing unit is further configured to, based on the first timing result, the first digital signal, the second timing result, and the second digital signal, or based on the first timing result, the first digital signal, the fourth timing result, and the fourth digital signal, compensate for the first digital signal, after determining that there is echo superposition in the echo signal.

11. The LiDAR system according to claim 10, wherein the processing unit is configured to compensate for the first digital signal by:
multiplying amplitude data of the echo signal determined as experiencing the echo superposition by a compensation coefficient less than 1.

12. The LiDAR system according to claim 9, wherein
based on the first timing result, the first digital signal, the second timing result, and the second digital signal, or based on the first timing result, the first digital signal, the fourth timing result, and the fourth digital signal, when determining whether there is echo superposition in the echo signal, the processing unit is configured to:
determine whether receiving time of a first digital signal segment with a value of 1 is overlapped with receiving time of a fourth digital signal segment with a value of 0, and overlapped duration exceeds a third duration threshold, or whether receiving time of a fourth digital signal segment with a value of 1 is overlapped with receiving time of a second digital signal segment with a value of 0, and overlapped duration exceeds a fourth duration threshold; and
if at least one yes, determine that there is echo superposition in the echo signal.

13. The LiDAR system according to claim 6, wherein the N comparison units corresponding to each receiving unit comprise a third comparison unit, the third comparison unit comprises a third threshold, and the number of third comparison units is M.

14. An echo signal processing method, applied to the LiDAR system according to claim 1, the echo signal processing method comprising:
obtaining at least two digital signals and at least two timing results respectively corresponding to echo signals based on at least two thresholds, wherein the thresholds, the digital signals, and the timing results are in one-to-one correspondence; and
processing the echo signal based on the at least two digital signals and the at least two timing results.

15. An echo signal processing apparatus, comprising:
an obtaining module, configured to obtain at least two digital signals and at least two timing results respectively corresponding to echo signals based on at least two thresholds, wherein the thresholds, the digital signals, and the timing results are in one-to-one correspondence; and
a processing module, configured to process the echo signals based on the at least two digital signals and the at least two timing results.
